(19) United States
(12) Patent Application Publication
(10) Pub. No.: US 2026/0300937 A1
(43) Pub. Date: Oct. 1, 2026

(54) System For Management Of And Data Collection At Compost Sites

(71) Applicants: Brendan Baba, Providence, RI (US); Tess Feigenbaum, Providence, RI (US)

(72) Inventors: Brendan Baba, Providence, RI (US); Tess Feigenbaum, Providence, RI (US)

(21) Appl. No.: 19/488,924

(22) PCT Filed: Jun. 2, 2024
(86) PCT No.: PCT/US2024/032169

§ 371 Date: Dec. 1, 2025

Related U.S. Application Data
(60) Provisional application No. 63/470,494, filed on Jun. 2, 2023.

(51) Int. Cl. G06Q 10/30

(52) U.S. Cl. CPC G06Q 10/30

(57) ABSTRACT

A system for managing and tracking key data points of community composting operations and providing such data to team members is provided. Various properties of a compost batch can be measured. Data is generated and an electronic processing device, such as a mobile phone, desktop personal computer, laptop, hand-held tablet, or the like, is used for transmitting the data to an electronic storage device such as a computer server system for the benefit of various team members.

### CROSS-REFERENCE TO RELATED APPLICATIONS

The application claims the benefit of U.S. Provisional Patent Application No. 63/470,494 filed Jun. 2, 2023, the entire disclosure of which is hereby incorporated by reference.

### BACKGROUND OF THE INVENTION

### Field of the Invention

The present invention relates generally to a system for managing and tracking key data points of composting operations and providing such data to team members. Various properties of a compost batch can be measured. Data is generated and an electronic processing device, such as a mobile phone, desktop personal computer, laptop, hand-held tablet, or the like, is used for transmitting the data to an electronic storage device such as a computer server system for the benefit of various team members.

### Brief Review of the Related Art

In recent years, more consumers in both rural and city areas have become interested in composting operations. In general, composting refers to an aerobic method of decomposing organic solid waste, such as leaves and food scraps. If the correct mixture of water, oxygen, carbon, and nitrogen is present, then organisms can decompose the organic material into a humus-like compost, which can be used later as a fertilizer. Compost recipe calculators for calculating carbon to nitrogen (C:N) ratios based on bulk density and other feedstock data can be used in these composting processes. Composting can take different forms and be on different scales including small at-home processes and large commercial operations.

There are many small-scale composting processes that need monitoring to provide persons running the compost site with data. Monitoring helps provide composters with information as to the activity of the compost pile. Composters can use this information to better manage their operations and ensure compliance with local and state regulations and ease pipeline for certification of the composting operation.

For example, the feedstock of the composting process needs to be considered. That is, the composition of the incoming waste that will be processed needs to be monitored. It is known that composting requires a proper balance of “green” organic materials and “brown” organic materials. The intake of the “Green” organic material includes grass clippings, food scraps, and manure, which contain large amounts of nitrogen. “Brown” organic materials include dry leaves, wood chips, and branches, which contain large amounts of carbon but little nitrogen.

The particle size of the compost material is also important and preferably is monitored. Grinding, chipping, and shredding materials increases the surface area on which microorganisms can feed. Smaller particles also produce a more homogeneous compost mixture. If the particles are too small, however, they might restrict air from flowing freely through the pile.

The moisture level of the composting materials also needs to be monitored.

Microorganisms living in a compost pile need enough moisture to survive. Water is the key element that helps transport substances within the compost pile and makes the nutrients in organic material accessible to the moisture level of the composting materials also needs to be monitored. Microorganisms living in a compost pile need enough moisture to survive. Water is the key element that helps transport substances within the compost pile and makes the nutrients in organic material accessible to the microbes.

Proper aeration of the compost pile is another factor that needs to be considered.

Turning or otherwise aerating the compost pile allows decomposition to occur at a faster rate than anaerobic conditions. However, if too much airflow is provided, this can dry out the pile and impede the composting process.

Also, microorganisms that decompose the solid waste require a certain temperature range for optimal activity. Certain temperatures promote rapid composting and significant reduction of pathogens and weed seeds. It is important that the proper temperature be maintained to ensure a sanitary end-product and compliance with local regulatory standards.

Other qualitative and quantitative parameters that should be monitored include, for example, pH, odor, and measurement of the mass of the material once the composting process has started.

There is a need for a system for managing compost sites and batches that can help composters, particularly local community-scale composting operations. The system should have good site and batch management and data collection features so that it can provide valuable information and help composters with their operations. The proposed site management and data collection system of the present invention has many advantages, features, and benefits as described further below.

### SUMMARY OF THE INVENTION

The present invention provides a system for tracking key data points of composting operations and providing such data across a network to team members. The system can help optimize composting operations and demonstrate impacts. The system can also help demonstrate viability and secure the support needed to grow. Numerous stakeholders can benefit using the system of the present invention including, but not limited to, composters, municipalities, environmental agencies, funding companies, and residents and businesses.

In one preferred embodiment, the present invention provides a communications system for managing composting operations. The system comprises: a) a means for measuring properties on a compost batch and generating data based on the batch properties; b) an electronic processing device for transmitting the data to an electronic storage device such as, for example, a computer server, so that the data can be recorded; and c) allowing team members of the communication system to have access to the recorded data so that the team members can use such data for managing the composting operations.

The generated data can include a Data Receiving Level. In one preferred example, the Data Receiving level includes a data category selected from the group consisting of: Diversion Weights; Feedstock Source; Methodology Use; Feedstock and Mix Composition; and Contamination Notes; and combinations thereof.

The generated data can also include first and second Data Processing Levels. In one preferred example, the first Data Processing Level includes a data category selected from the group consisting of: Feedstock Additions; Temperature Recordings; Moisture Level Recordings; Activity Interactions; Carbon Dioxide Readings; Weather and Ambient temperature Readings; and Qualitative Observations; and combinations thereof. In one preferred example, the second Data Processing Level includes a data category selected from the group consisting of: Finished Product End Use; Finished Product Mix Ratios; and Testing Data; and combinations thereof.

In one example, the compost batch is a new batch, and the batch properties are selected from the group consisting of type of feedstock, weight of feedstock, source of feedstock, and combinations thereof. In another example, the compost batch is an existing batch and the batch properties are selected from the group consisting of moisture level and temperature and combinations thereof.

In another embodiment, a communications system for collecting and transmitting data from a compost batch is provided. The system comprises: a) an electronic processing device for collecting data from the compost batch and transmitting the data to an electronic storage device such as, for example, a computer server so that the data can be stored. Different electronic processing devices such as, for example, mobile phones, desktop personal computers, laptops, and hand-held tablets can be used.

For example, the compost batch can be aerated and data relating to the aeration is transmitted to the electronic storage device. In a second example, water can be added to the compost batch and data relating to the addition of the water can be transmitted to the electronic storage device. In another example, the feedstock can be added to the compost batch and data relating to the feedstock can be transmitted to the electronic storage device. In yet another example, the compost batch can be sifted and data relating to the sifting of the batch can be transmitted to the electronic storage device.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a schematic diagram of a composter following one embodiment of a process of the present invention;

FIG. 2 is a schematic diagram of a composter following the process shown in FIG. 1 including detailed steps;

FIG. 3 is a flow chart showing steps for a communications network system following one embodiment of a process of the present invention;

FIG. 4 shows a graphical interface with a log-in step for one embodiment of the system of the present invention;

FIG. 5 shows a graphical interface with a step for adding a new batch log-in step for one embodiment of the system of the present invention;

FIG. 6 shows a graphical interface with steps for reviewing an existing batch and recording data for one embodiment of the system of the present invention;

FIG. 7 shows a graphical interface with steps for recording actions and performing actions such as turning or aerating of the compost batch for one embodiment of the system of the present invention;

FIG. 8 shows a graphical interface with steps for adding feedstock and sifting/removing material for one embodiment of the system of the present invention;

FIG. 9 shows a graphical interface wireframe, wherein data for Temperature, Action, Feedstock, and Sifting/Removing Steps is recorded for one embodiment of the system of the present invention;

FIG. 10, is a block diagram showing one embodiment of data capture and synthesis flow for the system of the present invention;

FIG. 11 is a block diagram showing different examples of data applications for a Composter using the system of the present invention in a composting operation;

FIG. 12 is a block diagram showing different examples of data applications for a Regulator/Permitter/Local Environmental Agencies using the system of the present invention;

FIG. 13 is a block diagram showing different examples of data applications for Clients/Customers and Waste Producers using the system of the present invention;

FIG. 14 is a block diagram showing different examples of data applications for Municipal Leaders using the system of the present invention;

FIG. 15 is a block diagram showing different examples of data applications for a Certification Body using the system of the present invention;

FIG. 16 is a block diagram showing different examples of how persons who are interested in funding the composting operations (Funders) can use the generated data of the system of the present invention; and

FIG. 17 is a block diagram showing different examples of how Retailers and Buyers of the finished product can use the generated data of the system of the present invention.

### DETAILED DESCRIPTION OF THE INVENTION

The present invention relates generally to a communications system, wherein various properties of a compost batch can be measured. Data is generated from the measurements and an electronic processing device, such as a mobile phone, desktop personal computer, hand-held tablet, laptop, or the like is used for transmitting the data to an electronic storage device such as a computer server system. Various stakeholders can use the generated data in connection with the compositing operations. The monitoring of the compost sites and batches can be done in any suitable manner including, but not limited to, visual observations, manual inspection, and scientifically-advanced instruments and devices. For example, scientific probes or simple thermometers can be used to take the temperature of a compost pile.

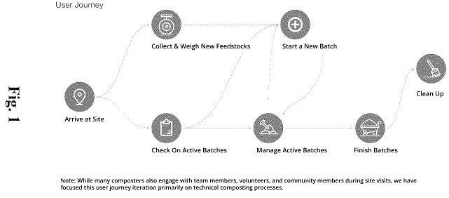

FIG. 1 shows a general schematic representation of one example of a journey of a composter (user) employing the communications network of the present invention. The user starts the journey when arriving at the composting site; and then follows pathway a) which involves collecting and weighing new feedstocks at the start of the composting process; or pathway b) which involves checking on the active compost batches. New composting batches can be started and/or active batches can be managed in accordance with the communications system of the present invention. These steps are described in further detail below. As shown in FIG. 1, in the finishing step, the compost batches are then sifted and/or moved into a curing phase or otherwise packaged for distribution. This action is followed by a cleaning-up step.

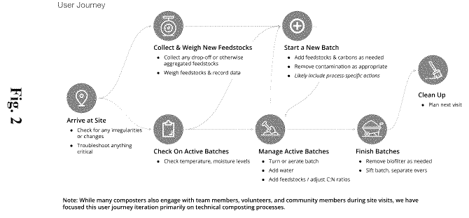

Referring to FIG. 2, the journey of the composter (user) is shown in more detail.

After arriving at the compost site, the composter checks for any irregularities or changes. In the collecting and weighing step for the new feedstocks, any drop-off compost material is collected, or the feedstocks are otherwise aggregated. The compost feedstock is weighed, and this data is recorded. As described in FIG. 2, when the user checks on the active batches, this step can involve monitoring temperature and moisture levels, aeration, particle size, and other properties.

As shown in FIG. 2, starting a new compost batch involves several steps including adding feedstock and carbons, as needed, and removing contamination. When managing active compost batches, different actions such as turning or aerating the batch, adding water, adding feedstocks, and adjusting carbon to nitrogen ratios might be needed. In the finishing step, the biofilter for the compost pile might need to be removed and the batch sifted.

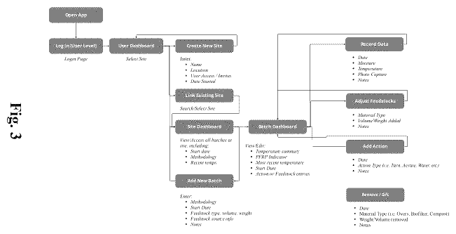

Turning to FIG. 3, the steps of one embodiment of the communications network of the present invention are shown in further detail. The core functionality map of FIG. 3 shows highlighted sections that indicate a navigational screen. Some of these screens have secondary pages for data input. The network includes a data processing device such as a mobile phone, desktop personal computer, hand-held tablet, laptop, or the like. As described in FIG. 3, the user of the system first logs into the computer program following a log-in prompt that may include inputting a password. Then, the user receives a prompt and must decide whether to create a new compost site or manage an existing compost site. If the user selects the option, “creating a new site,” then the user will need to input the name and location of the site. If the user selects “managing an existing site,” the user will need to select between “create and manage new batch” or “manage existing batch.” By the term, “batch” as used herein, it is meant a single collection of compost feedstocks going through a single composting process. By the term, “site” as used herein, it is meant all compost batches at a specific location. By the term, “composting operations”, it is meant any activity relating to a compost batch or site.

When a new compost batch is created, the type and weight/volume of compost feedstock, source information, and methodology should be entered into the communications system. Other notes on the new compost batch can also be entered at this point. If an existing compost batch is to be managed, then data for the batch should be entered. For example, the date, moisture level, and temperature of the compost batch should be entered. Photos and other notes can also be entered at this point. Next, various action items for managing the compost batch can be entered. For example, the steps of turning/aerating the compost batch (date and notes); adding feedstock (material type, weight, and notes); adding water; and sifting the batch/removing biofilter (weight removed, screen size, overs weight, and notes) can be inputted.

Different data sets for the compost site and/or compost batches can be recorded. For example, the compost feedstock volume/weight, type, source, and qualitative observations can be recorded. In addition, the compost batch temperatures, moisture levels, photos, and qualitative observations can be recorded. There are also different actions or batch compost interactions that can be taken. This information includes dates, notes, relevant data, and the like for; i) turning/aeration (date and qualitative observations or known quantitative volumes, i.e. cubic feet per minute) of the compost batch; ii) water additions (volume/weight and notes), iii) feedstock additions (feedstock type, source, volume/weight, and notes/qualitative observations); and iv) sifting/removal (volume of finished compost set to cure, screening size of sifted material, and volume of materials considered overs (larger remnants).

Also, the computer application software preferably includes a timeline view of batch temperatures and a PFRP indicator (badge or push notification when the compost pile has passed the requirements to be considered sanitary/finished with critical composting time window for pathogen reductions.) In other embodiments, the application software includes an overlaid visualization of moisture levels and interactions, total water used to date, total feedstock included to date, and an action summary/timeline.

The reporting features via email, desktop, or mobile preferably include data on total diversion (may be paired with CO2 offset equivalent); feedstock percentages; feedstock sources; and full batch history (temps, feedstocks, interactions, and the like); and the total amount of water used.

As discussed above, different electronic processing devices, such as a mobile phone, desktop personal computer, hand-held tablet, laptop, or the like can be used in the communications system of the present invention. The processing device includes at least one microprocessor, a memory, and a visual display. An interface (for example, wired or wireless network) can be used for connecting the processing device with an electronic storage device such as a computer server system.

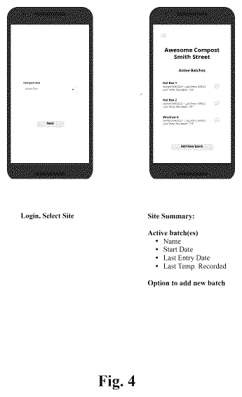

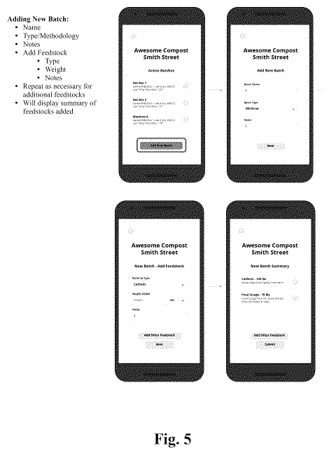

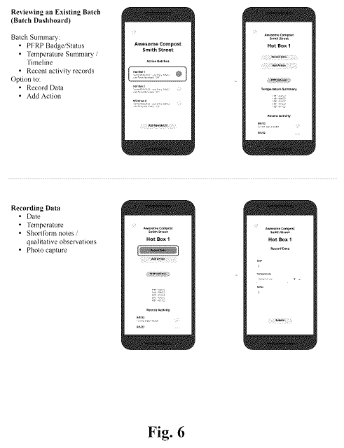

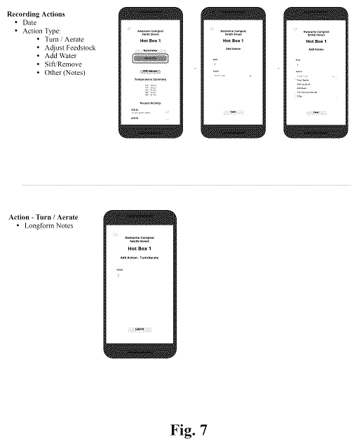

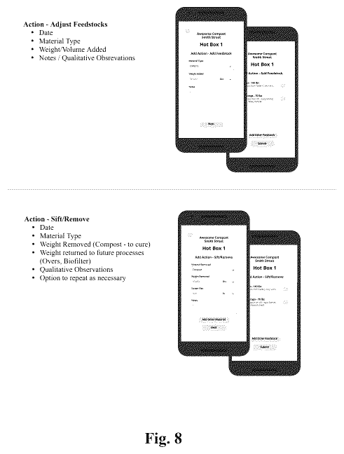

Referring to FIGS. 4-8, different wireframes are shown. As shown in FIGS. 4-8, in the application software, each question or prompt is displayed on the visual display of the processing device, for example, cell phone. The user, in response to each question or prompt loaded on the screen, enters the appropriate information. The next question is then displayed on the screen and transmitted to the user. Again, the user enters the information. This process continues until all requested information is input into the communications system. Once the information has been processed, it is sent to an electronic storage device such as a computer server system. The collected data from the compost site and/or batch can be stored in a local database and cloud-based system. After the data from the electronic processing device is transmitted to an electronic storage device so that the data can be recorded, wherein users can access the data for monitoring the compost batch. One key feature of the system and process of the present invention is that a wide variety of stakeholders can utilize the generated data in specific ways for their individual needs. As discussed further below, different stakeholders can gain significant benefits and advantages using the system and process of the present invention.

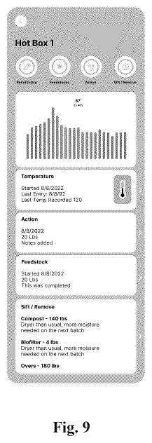

FIG. 9 shows another wireframe, wherein data for Temperature, Action, Feedstock, and Sifting/Removing Steps is recorded. One advantage of the system of the present invention is that it can provide effective feedstock analysis including, but not limited to, monitoring of available total feedstocks and availability of feedstock capacity.

The present invention provides an efficient service information management system for compost production. The system tracks complex composting processes and impact data. The system enables composters to improve operations. The system enables transformative growth for community composters. Composting processes are quickly summarized, and impact data is effectively reported using the system of the present invention. In particular, there are many benefits and advantages for different stakeholders to use the data collected and transmitted in accordance with the system and process of the present invention as discussed further below.

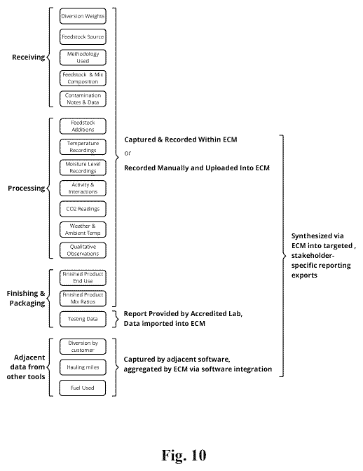

Referring to FIG. 10, a block diagram showing one embodiment of data capture and synthesis flow for the system of the present invention is shown. In FIG. 10, the system includes a Data Receiving Level that generates the following examples of data: Diversion Weights; Feedstock Source; Methodology Use; Feedstock and Mix Composition; and Contamination Notes and Data; and combinations thereof.

In FIG. 10, the first system also includes a first Data Processing Level. As shown in FIG. 10, the first Data Processing Level includes: Feedstock Additions; Temperature Recordings; Moisture Level Recordings; Activity Interactions; Carbon Dioxide (CO2) Readings; Weather and Ambient temperature Readings; and Qualitative Observations; and combinations thereof. This data can be captured and recorded within the Epic Compost Management (ECM) system of the present invention, or it can be recorded manually an uploaded into the ECM system.

In FIG. 10, the second Data Processing Level includes: Finished product End Use; Finished Product Mix ratios; and Testing Data; and combinations thereof. A Testing Data report can be provided by an accredited laboratory; and data can be imported into the Epic Compost Management (ECM) system of the present invention. Adjacent Data from other tools also can be used in the system of the present invention. For example, as shown in FIG. 10, there can be tools for Diversion by Customers; Hauling Miles; and Fuel Used. Information and data from these tools can be captured by the Epic Compost Management (ECM) systems and aggregated by ECM via software integration.

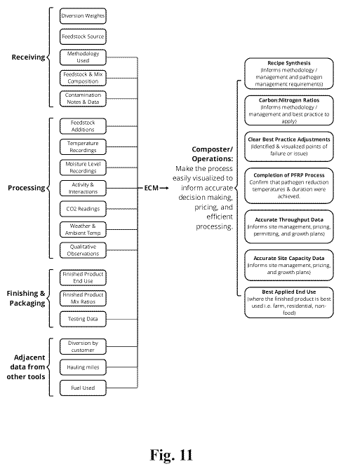

In FIG. 11, a block diagram showing different examples of data applications for a Composter running a composting operation is shown. The program in FIG. 11 includes the same Receiving, Processing, and Other Tool Levels as shown in FIG. 10. In the program shown in FIG. 11, the Composter can use the generated data to easily visualize the composting process and to make informed and accurate decision making, pricing, and efficient processing.

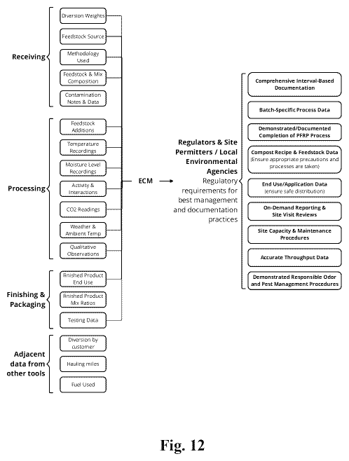

As shown in the block diagram of FIG. 12, there are different examples of data applications for Regulators and Site Permitters/Local Environmental Agencies. The program in FIG. 12 includes the same Receiving, Processing, and Other Tool Levels as shown in FIG. 10. In the program shown in FIG. 12, the Regulator/Permitter/Local Environmental Agencies can use the generated data to enforce regulatory requirements and for best management and documentation practices.

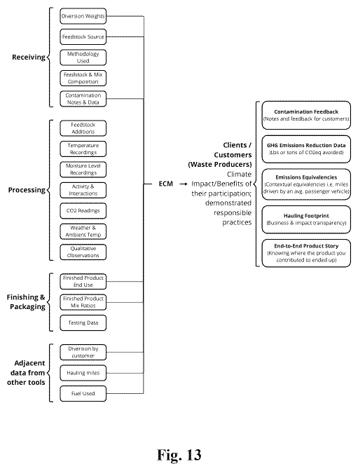

In FIG. 13, there are different examples of data applications for Clients/Customers and Waste Producers. The program in FIG. 13 includes the same Receiving, Processing, and Other Tool Levels as shown in FIG. 10. In the program shown in FIG. 13, the Clients/Customers and Waste Producers can use the generated data for understanding the impacts and benefits of their participation. The data also can be used for developing and demonstrating responsible practices.

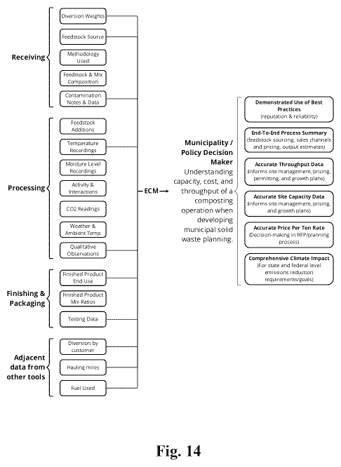

Turning to FIG. 14, the block diagram shows different examples of data applications for Municipal Leaders. The program in FIG. 14 includes the same Data Receiving, Processing, and Other Tool Levels as shown in FIG. 10. In the program shown in FIG. 14, the Municipal Leaders can use the generated data for understanding capacity, cost, and throughput of a composting operation. This data can be helpful to Municipal leaders when developing municipal solid waste planning programs.

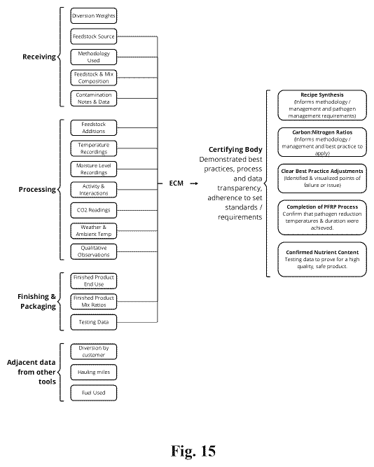

Referring to FIG. 15, the block diagram shows different examples of data applications for a Certification Body. Such Certification Bodies are needed for sales. The program in FIG. 15 includes the same Data Receiving, Processing, and Other Tool Levels as shown in FIG. 10. In the program shown in FIG. 15, the Certification Body can use the generated data for best practices, process and data transparency, and improve adherence to set standards/requirements.

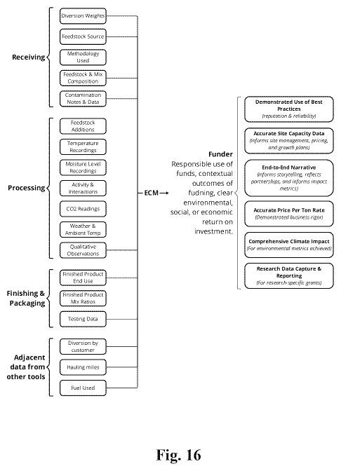

In FIG. 16, the block diagram refers to examples of how persons who are interested in funding the composting operations (Funders) can use the data. The program in FIG. 16 includes the same Data Receiving, Processing, and Other Tool Levels as shown in FIG. 10. In the program shown in FIG. 16, the Funders can use the data to make decisions around funding.

The generated data helps the Funders and Composters to responsibly use the funds; understand the contextual outcomes of the funding; and clearly understand the environmental, social, or economic return on investment.

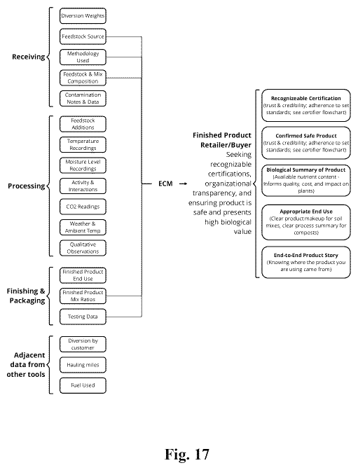

In FIG. 17, the block diagram refers to examples of how Retailers and Buyers of the finished product can use the generated data. The program in FIG. 17 includes the same Data Receiving, Processing, and Other Tool Levels as shown in FIG. 10. In the program shown in FIG. 17, the Retailers and Buyers can use the data generated in these different Levels to seek recognizable certifications, organizational transparency, and for ensuring that products are safe and have high biological value.

As discussed above, a wide variety of properties of compost sites and batches can be measured in accordance with the present invention. Also, different monitoring methods and instruments can be used to monitor the compost sites and batches. For example, the temperature, interactions (compost pile that is created and turned, materials added to the compost pile, and the like.) In addition, feedstock volume and weight (for example, food scraps, wood chips, leaves, and other decomposable matter can be monitored. The total volumes of the finished materials also can be monitored. The composition of the compost batches, in terms of general weight percentages as well as direct measurements of the materials added to the compost can be monitored. It is expected that a full audit trail from the collection of the starting compost material to the delivery of the finished products can be made in accordance with the present invention.

Once the data for the compost site and batches is collected, the data can be analyzed, and this leads to better management of the areas. For example, the total volumes received, various time metrics, stock quantities, sales prices, sales volume, and the like can be analyzed. Other metrics that can be analyzed include total available processing capacity and availability. Local availability of additional processing capacity (feedstock redirection and capacity sharing) also can be evaluated. The data also can be used to audit trails of personal performing tasks. There also can be studies on compost batches meeting PFRP (process to further reduce pathogens) standards.

The data and information can be presented in a variety of formats and view capabilities. These views can be restricted/controlled based on job duties. Information is accessible and can be input via mobile applications and automatically transmitted to a central server for remote and collective data storage. Additional controls and reports can be made from desktop and other computer applications. These reports can be made available at the levels of individual compost batches, sites, company, locale, and national metrics.

The present invention provides many benefits and advantages as a management system for compost production. The systems and processes of the present invention tracks composting processes and impact data. This critical information enables community composters to improve operations and build a foundation for growth.

The present invention provides a system for easily tracking key data points onsite and across a network to team members. The system can quickly summarize composting processes and report impact data. The system can help optimize composting operations and demonstrate impacts. The system can also help demonstrate viability and secure the support needed to grow. As discussed above, a wide variety of stakeholders can benefit using the system of the present invention including, but not limited to, municipalities, environmental agencies, funding companies, and residents/businesses.

It should be understood the systems, methods, processes, and the like described and illustrated herein represent only some embodiments of the invention. It is appreciated by those skilled in the art that various changes and additions can be made to the systems, methods, processes, and the like without departing from the spirit and scope of this invention. It is intended that all such embodiments be covered by the appended claims.

We claim:

1. A communications system for managing composting operations, comprising:
a means for measuring properties on a compost batch and generating data based on the batch properties; and
an electronic processing device for transmitting the data to an electronic storage device so that the data can be recorded; and
allowing team members of the communication system to have access to the recorded data so that the team members can use such data for managing the composting operations.

2. The system of claim 1, wherein the compost batch is a new batch, and the batch properties are selected from the group consisting of type of feedstock, weight of feedstock, source of feedstock, and combinations thereof.

3. The system of claim 1, wherein the compost batch is an existing batch, and the batch properties are selected from the group consisting of moisture level and temperature and combinations thereof.

4. The system of claim 1, wherein the electronic processing device is selected from the group consisting of mobile phones, desktop personal computers, laptops, and hand-held tablets.

5. The system of claim 4, wherein the electronic processing device is a mobile phone.

6. The system of claim 1, wherein the electronic storage device is a computer server.

7. The system of claim 1, wherein the generated data includes a Data Receiving Level.

8. The system of claim 7, wherein the Data Receiving Level includes a data category selected from the group consisting of Diversion Weights; Feedstock Source; Methodology Use;
Feedstock and Mix Composition, and Contamination Notes; and combinations thereof.

9. The system of claim 1, wherein the generated data includes first and second Data Processing Levels.

10. The system of claim 9, wherein the first Data Processing Level includes a data category selected from the group consisting of: Feedstock Additions; Temperature Recordings; Moisture Level Recordings; Activity Interactions; Carbon Dioxide Readings; Weather and Ambient temperature Readings; and Qualitative Observations; and combinations thereof.

11. The system of claim 9, wherein the second Data Processing Level includes a data category selected from the group consisting of Finished Product End Use; Finished Product Mix Ratios; and Testing Data; and combinations thereof.

12. A communications system for collecting and transmitting data from a compost batch, comprising:
an electronic processing device for collecting data from the compost batch and transmitting the data to an electronic storage device so that the data can be stored; and
allowing team members of the communication system to have access to the stored data so that the team members can use such data for managing composting operations.

13. The system of claim 12, wherein the electronic processing device is selected from the group consisting of mobile phones, desktop personal computers, laptops, and hand-held tablets.

14. The system of claim 13, wherein the electronic processing device is a mobile phone.

15. The system of claim 12, wherein the electronic storage device is a computer server.

16. The system of claim 12, wherein the compost batch is aerated and data relating to the aeration is transmitted to the electronic storage device.

17. The system of claim 12, wherein the compost batch is a new batch, and the batch properties are selected from the group consisting of type of feedstock, weight of feedstock, source of feedstock, and combinations thereof.

18. The system of claim 17, wherein feedstock is added to the compost batch and data relating to the feedstock is transmitted to the electronic storage device.

19. The system of claim 12, wherein the compost batch is an existing batch and the batch properties are selected from the group consisting of moisture level and temperature and combinations thereof.

20. The system of claim 19, wherein water is added to the compost batch and data relating to the addition of the water is transmitted to the electronic storage device.
